(19) United States
(12) Patent Application Publication
(10) Pub. No.: US 2016/0177631 A1
(43) Pub. Date: Jun. 23, 2016

(54) WELL INTERVENTION MONOHULL VESSEL

(71) Applicant: HELIX ENERGY SOLUTIONS GROUP, INC., Houston, TX (US)

(72) Inventor: Hin Chiu, Sugar Land, TX (US)

(21) Appl. No.: 14/977,184

(22) Filed: Dec. 21, 2015

Related U.S. Application Data
(60) Provisional application No. 62/095,758, filed on Dec. 22, 2014.

(51) Int. Cl. E21B 15/02; B66C 23/52; B63B 35/44

(52) U.S. Cl. CPC E21B 15/02; B63B 35/44; B66C 23/52

(57) ABSTRACT

A well intervention monohull vessel and method of use including a tower type open derrick disposed on a deck of the vessel and a single point land out. The vessel may also include an intervention riser system, an emergency disconnect package, a moonpool door preferably capable of transporting the intervention riser system, an intervention lift frame, a surface coiled tubing reel, a riser storage area, a rail, a pallet, a subsea tree, a crane, and/or a drawork.

### CROSS REFERENCE TO RELATED APPLICATIONS

This nonprovisional application for patent claims priority to, and hereby incorporates by reference, U.S. Provisional Application Ser. No. 62/095,758, entitled “Well Intervention Monohull Vessel,” filed Dec. 22, 2014.

### BACKGROUND OF THE INVENTION

### Technical Field of Invention

The invention disclosed and taught herein relates generally to a system and method for use in floating offshore environments including drilling rigs. The embodiments described below relate generally to the design layout of equipment on an offshore well intervention monohull vessel specifically for the transport, deployment, and retrieval of well intervention subsea equipment.

### BACKGROUND OF THE INVENTION

A typical layout of an exploratory drilling rig is to place a pyramid type drilling derrick at or near the center of the upper deck with an “elevated drill floor.” This type of derrick is usually built of truss structures with the drilling equipment installed within its footprint boundary. A drilling riser would be installed through the rotary table on the drill floor and connected to the subsea well. It is essentially a conduit for running the drill string to the well bore below and allowing the return of mud flow through the riser annulus to the surface. At the bottom of the drilling riser, there is a safety device called the subsea BOP Stack (Blow Out Preventer) latched on the wellhead and the LMRP (Lower Marine Riser Package). The BOP stack is designed to have the mechanism to shear off the drill string and shut in the well for well control purpose. Whereas the LMRP provides the quick disconnect mechanism of the riser on the top of the BOP in the event the drilling vessel is required to move away from the well that is out of control. The typical size of a deep water drilling riser joint has about a 21 inch outer diameter, about 75 feet in length, and with over about 50 inch of diameter for the buoyancy material attached. For deep water application, the combined BOP stack and LMRP can reach over 60 feet tall and the combined weight over 300 metric tonnes depending on the number of rams being configured on the BOP. Accordingly, the equipment for assembling, handling, transporting, and positioning the massive BOP stack and the LMRP underneath the drill floor becomes the center issue in the drilling system design layout. In order to provide sufficient head room for this operation, an elevated drill floor is normally required in the layout. Such an elevated drill floor is supported by the “derrick substructures” installed on top of the main deck.

The design of a well intervention monohull vessel, however, is not intended for drilling of a new well to the reservoir formation. Instead, its primary function is to provide down hole work-over service of a well that has been produced for a period of time. A typical well intervention operation can be performed by means of different methods including slick line, electric line, and coiled tubing deployment through the riser. The corresponding well intervention riser has a smaller diameter in comparison with a drilling riser, usually in the range of 7 to about 8.5 inch outer diameter. Unlike the drilling of an exploratory or development well, the physical characteristics of the well and the composition of the well stream are usually known prior to the well intervention operation. The use of a full size drilling BOP stack and LMRP is considered as overkill for well intervention.

### SUMMARY OF THE INVENTION

Riser based monohull operations traditionally involve a drilling rig with an elevated drill floor. This arrangement works well for drilling operations since the focus is on pipe handling efficiency. A preferred method for well intervention includes operating a flat flush deck 101 monohull without an elevated drill floor. This approach enables the user to handle pipes like a drilling rig but also to handle the subsea equipment and the surface well service equipment more efficiently than a drilling rig arrangement. One advantage of this approach is the ability to rig equipment up and rig equipment down quickly when intervening on a well. A drilling rig is on a well for months at a time so pipe handling efficiency is important whereas intervention operations take on average 10 to 15 days so equipment change out for different operations as well as pipe handling is the key to efficient operations due to the higher frequency of equipment change out.

The combination of flat deck, i.e., no elevated substructure, and a tower type open derrick structure 102 combined with heavy lift crane capability provides a unique operating aspect to normal monohull operations for subsea well intervention work. The user is able to accommodate the heavy equipment associated with subsea well intervention operations (subsea trees 103 and manifolds and surface coiled tubing reels 104 and intervention lift frames 105). The flat, flush and open deck design permits ease of movement of equipment, compared to traditional drill ships.

The equipment handling capabilities based around the use of the flat, flush and open deck design further enhances well intervention operations through elimination of the riser tensioners for use with the intervention riser system when operations allow. Eliminating the use of riser tensioners increases the efficiency with which equipment rig up, handling, deployment and rig down is accomplished. During operations with the intervention riser system attached to the well riser tension is accomplished via a single point land out 106 through maintaining the riser tension from the derrick structure 102. The combination of passive heave compensation to limit the vessel motion being imparted to the intervention riser system and the active heave compensation in line with the passive heave compensation provides the operational redundancy required during single point land out operations and eliminates the requirement for riser tensioners as an operating mode option.

An additional feature is the ability to rig up, handle, and deploy and rig down well service equipment covering pressure control equipment, coiled tubing equipment and electric line and slick line. A self-standing skidding intervention lift frame 105 of box construction enables access to the well service equipment once rigged up over the well.

### DESCRIPTION OF THE DRAWINGS

FIG. 1 shows a side, cross sectional view diagram of an embodiment of a conventional drill ship.

FIG. 2 shows a side, cross sectional view diagram of an embodiment of a conventional drill ship.

FIG. 3 shows a close-up, perspective view of a layout of a well intervention rig and the transport of an intervention riser system IRS from the assembly position to the well center in transverse direction.

FIG. 4 shows a close-up, perspective view of a layout of a well intervention rig and the intervention lift frame in position above the moon pool.

FIG. 5 shows an overhead plan view diagram of a well intervention monohull main deck layout embodiment.

FIG. 6 shows a side, cross sectional view of a well intervention monohull embodiment.

FIG. 6A shows a side, cross sectional view of the moonpool of a well intervention monohull embodiment.

FIG. 7 shows a side, cross sectional view of a well intervention monohull embodiment.

FIG. 8 shows a close-up, perspective view of the upper deck layout of a monohull embodiment.

### DESCRIPTION OF THE DISCLOSED EMBODIMENTS

The drawings described above and the written description of specific structures and functions below are presented for illustrative purposes and not to limit the scope of what has been invented or the scope of the appended claims. Nor are the drawings drawn to any particular scale or fabrication standards, or intended to serve as blueprints, manufacturing parts list, or the like. Rather, the drawings and written description are provided to teach any person skilled in the art to make and use the inventions for which patent protection is sought. Those skilled in the art will appreciate that not all features of a commercial embodiment of the inventions are described or shown for the sake of clarity and understanding.

Persons of skill in this art will also appreciate that the development of an actual, real-world commercial embodiment incorporating aspects of the inventions will require numerous implementation specific decisions to achieve the developer's ultimate goal for the commercial embodiment. Such implementation specific decisions may include, and likely are not limited to, compliance with system related, business related, government related and other constraints, which may vary by specific implementation, location and from time to time. While a developer's efforts might be complex and time consuming in an absolute sense, such efforts would nevertheless be a routine undertaking for those of skill in this art having the benefit of this disclosure.

It should also be understood that the embodiments disclosed and taught herein are susceptible to numerous and various modifications and alternative forms. Thus, the use of a singular term, such as, but not limited to, “a” and the like, is not intended as limiting of the number of items. Similarly, any relational terms, such as, but not limited to, “top,” “bottom,” “left,” “right,” “upper,” “lower,” “down,” “up,” “side,” and the like, used in the written description are for clarity in specific reference to the drawings and are not intended to limit the scope of the invention or the appended claims.

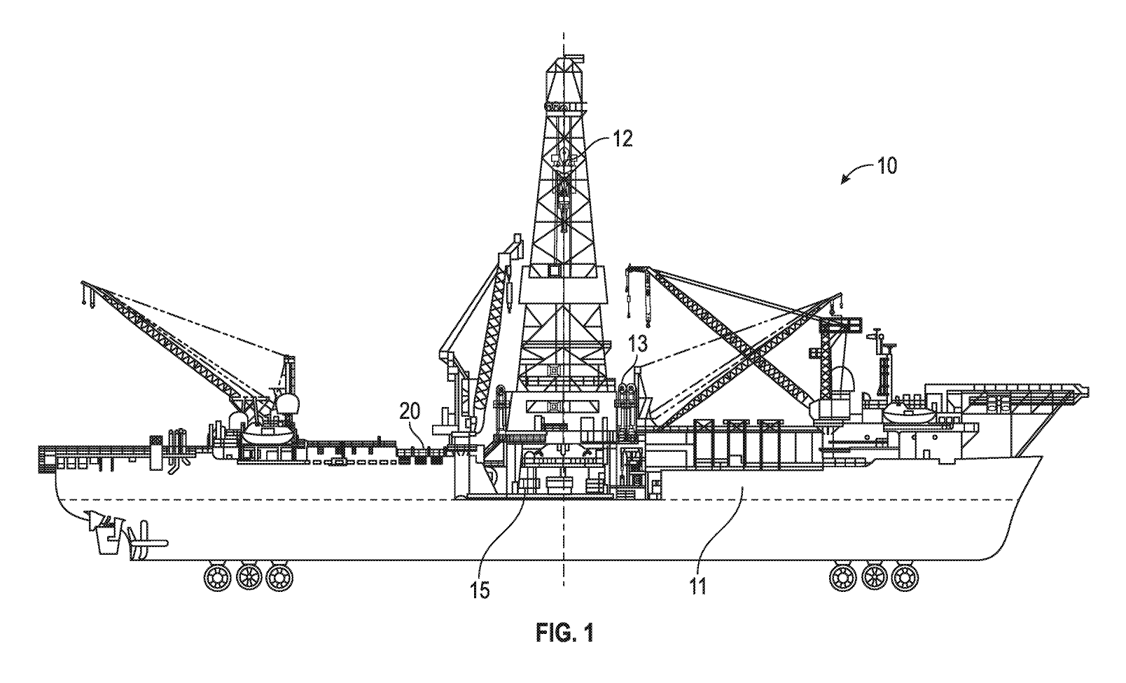

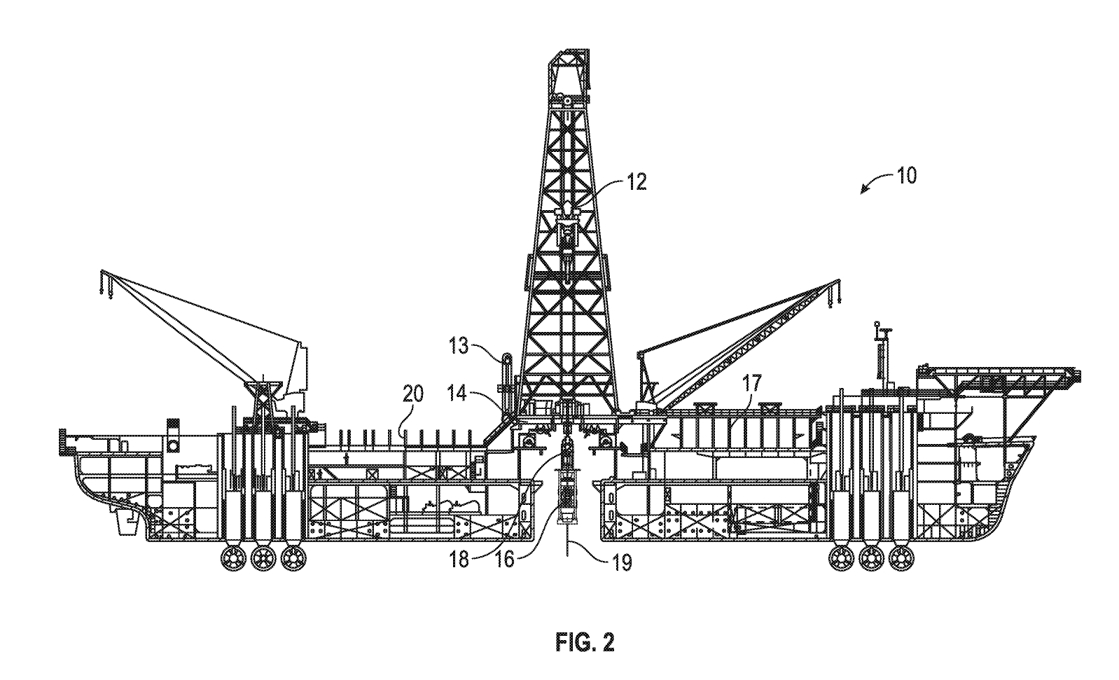

FIGS. 1 and 2 show cross sectional, side views of a conventional drilling ship 10 with an embodiment of an elevated drill floor 14 and the deployment of a blowout preventer BOP stack 16 and lower marine riser package LMRP 18 below the elevated drill floor 14. The main deck 11 is visible with a derrick substructure 15. Riser tensioners 13 are connected to a pyramid type truss derrick 12. Riser racks 17, a moon pool 19, and pipe racks 20 are incorporated into this design.

In contrast, a monohull vessel 100 is designed to have a ship shape hull form. The functional requirements of the hull are to provide the proper buoyancy and structural integrity for supporting the whole unit, and to provide the space for the machinery such as thruster rooms, pump rooms, etc., and liquid storage for ballast water, fresh water, fuel, and oil field related liquids.

The draft, dimensions, and geometry of the hull determine the motion characteristics of the unit in waves. Moreover, the breadth, water plane area together with the vertical center of gravity of the unit determine the stability of the unit.

In general, a monohull vessel 100 for offshore oil and gas operation can be described in five different sub-categories based on their primary functional requirements, namely: to perform exploratory drilling and well construction; to perform well intervention operation; to perform subsea installation and construction operations; to produce oil and gas; and to provide accommodation living quarters.

The equipment layout of the design is determined by the mission and hence the functional requirements of the unit in question. An optimum design layout for a specific rig category may not be applicable to the other categories at all. For example, if a drilling ship in category one is used to perform well intervention operation, its operating efficiency may suffer due to its inherent equipment arrangement on the deck and the associated deployment procedure of subsea equipment to the sea floor. Conversion of a drill ship to a well intervention ship would lead to similar restrictions in operation.

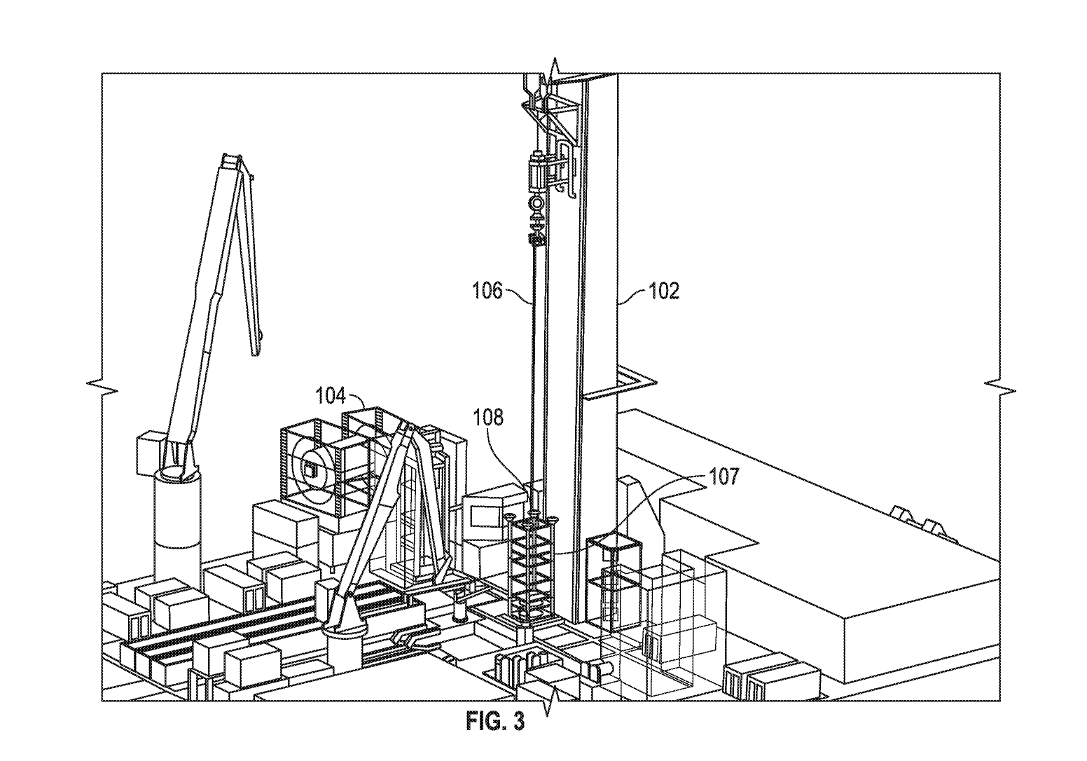

The monohull vessel 100 is shown starting in FIG. 3, a purposed design of subsea valve blocks also known as the Intervention Riser System (IRS) 107 together with an Emergency Disconnect Package (EDP) 108 enable the well shut in capability and quick disconnect of the riser from the subsea well head to achieve optimum working efficiency for deployment and retrieval of the subsea well control equipment. The dimensional size of the IRS is substantially smaller and its weight is about ¼ to about ⅓ of a BOP stack. Because of the reduction of equipment size and weight, the optimum layout of a well intervention monohull has a revolutionary change of the deck layout which leads to a substantial improvement of the operating efficiency in terms of assembly, handling, deployment and retrieval of subsea equipment such as the IRS and riser system.

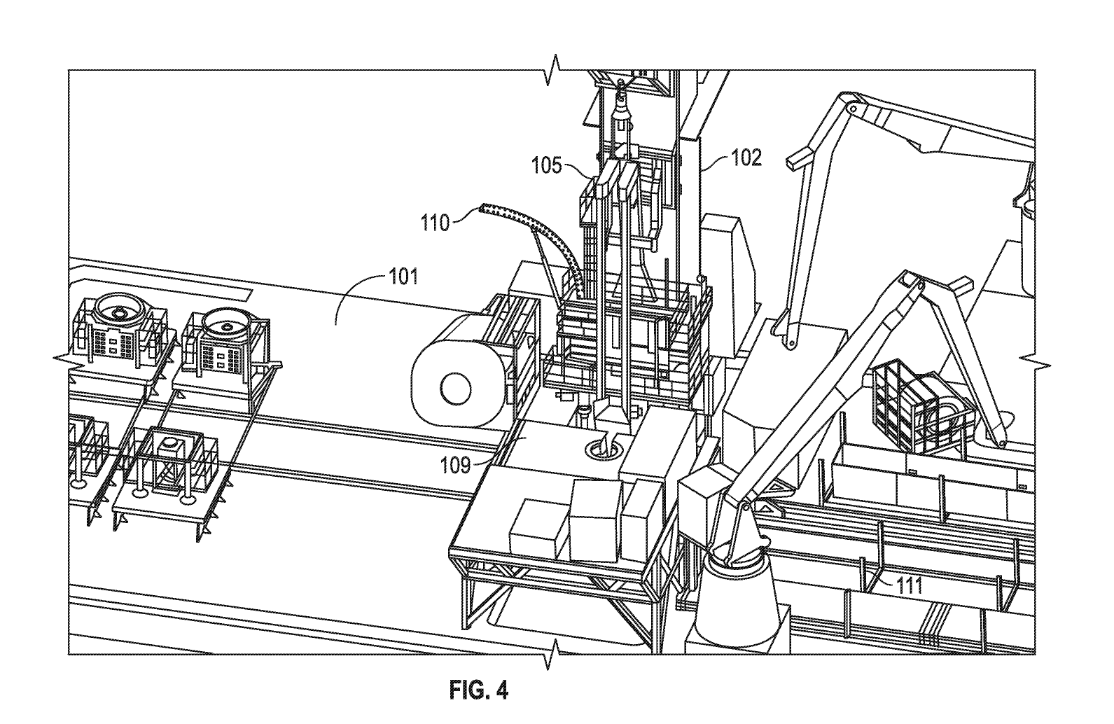

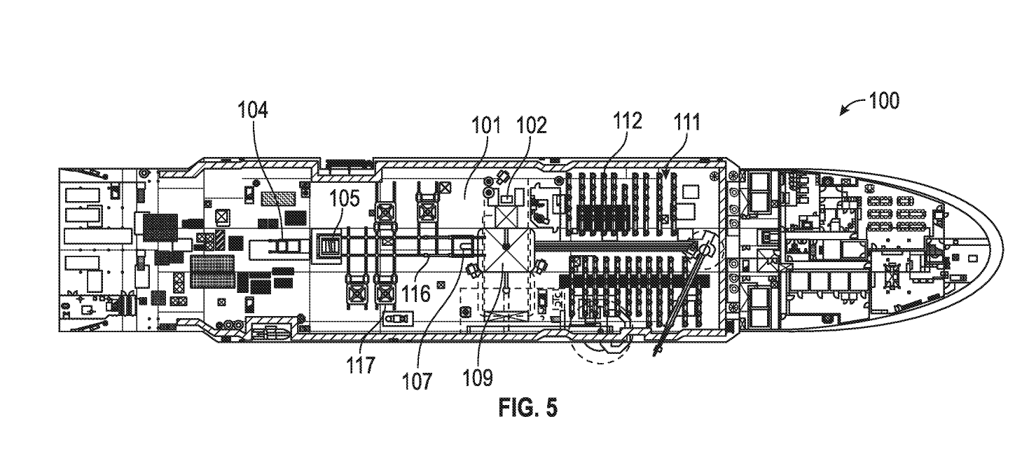

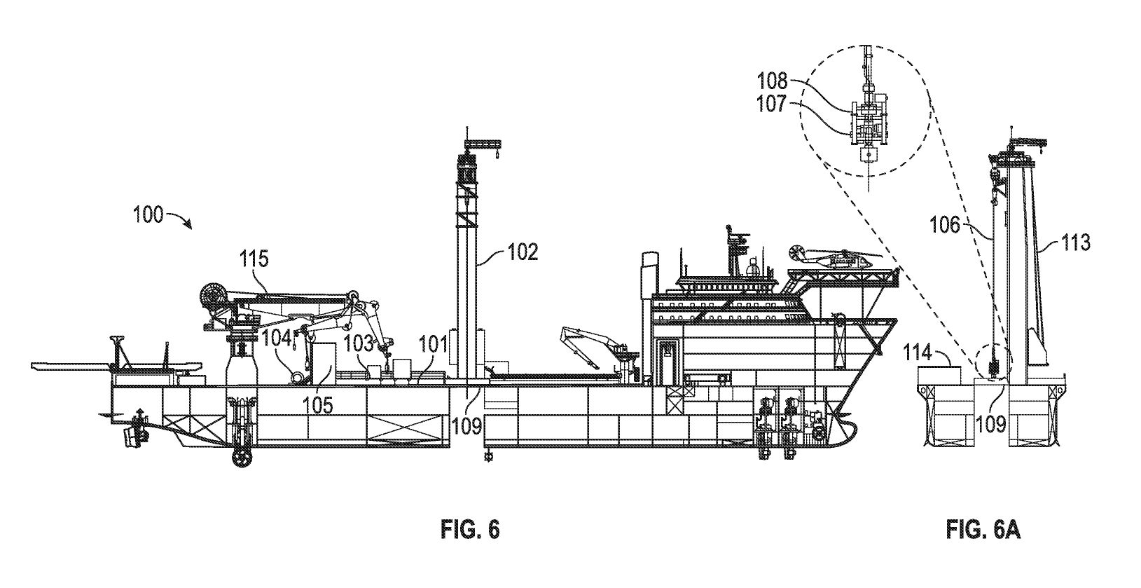

By using a tower type open derrick 102, the new concept allows the time to rig up the well intervention equipment such as slick line, electric line or surface coiled tubing reels 104 shown in FIGS. 4-8 much faster than the use of a traditional enclosed pyramid drilling derrick 12. The design concept features an open derrick 102 to be installed on a flat flush deck 101 shown in FIGS. 5 and 6 with a moonpool door 109 shown in FIG. 4 replacing an elevated drill floor 14 and derrick substructure 15 which are normally found on a conventional drill ship 10.

In a preferred embodiment, the layout of the upper deck with the use of an open derrick and a mechanized driven moon pool door 109. This moon pool door 109 preferably has dual functions: it features a power slip for running subsea equipment at the well center; and it can be used as a transporter for moving the IRS 107 from its assemble location to the deployed position at the well center, as shown in FIGS. 3 and 4. With this arrangement, the initial rig up time and the time for running and retrieval time of the IRS 107 and the riser to and from the sea floor can be greatly reduced. The total time for servicing a well become a fraction of that if it is performed on an exploratory drilling ship. The coil tubing goose neck 110 is also shown in FIG. 4.

The present invention eliminates the requirement for riser tensioners 13 and the correspondingly the riser telescopic joint by being able to have a single point land out 106 shown in FIG. 3 from a Multi-Purpose Tower (MPT) or equivalent open derrick 102. So the telescopic joint for the riser is optional. Additionally, no rotary table is needed and the moon pool door 109 is designed to have the same functionality as a drill floor and it offers the advantage of being able to slide deck equipment into and out of the deployment.

FIG. 4 shows the well intervention rig and the transport of the intervention lift frame 105 from the storage position to the well center via the deck 101 skidding capability for make up to the intervention riser system (IRS) 107. The riser storage area 111 is also shown herein.

FIG. 5 shows an overhead plan view diagram of the well intervention monohull vessel 100 where the moon pool door 109 moves in transverse direction of the deck 101. In this layout arrangement, the IRS stack 107 is transported by rails 116 via a pallet 117 on the deck 101 to the moon pool door 109. The deck 101 of the well intervention monohull vessel 100 may have the pallet 117 on the aft side of the moon pool door 109 or forward of the moon pool 109, and the pipe and riser storage area 111 on the aft side of the moon pool door 109.

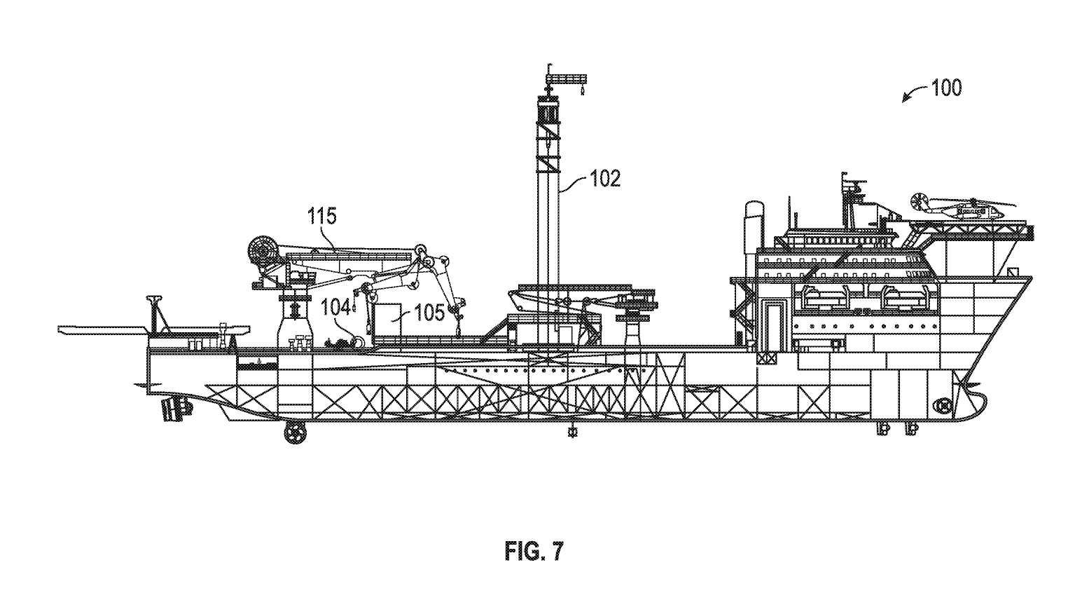

FIG. 6 shows a cross sectional side view of the vessel 100. The open derrick 102 is located on the deck 101 with the subsea trees 103 and the surface coiled tubing reels 104 present. The intervention lift frames 105 are shown disposed under the crane 115. As shown in FIG. 6A, the single point land out 106 over the moon pool door 109 is held in place by the drawwork 113 beside the raised platform 114. FIG. 7 shows a cross sectional, side view of the vessel 100 with the open derrick 102 is located on the deck 101 with the surface coiled tubing reels 104 and intervention lift frames 105 disposed under the crane 115.

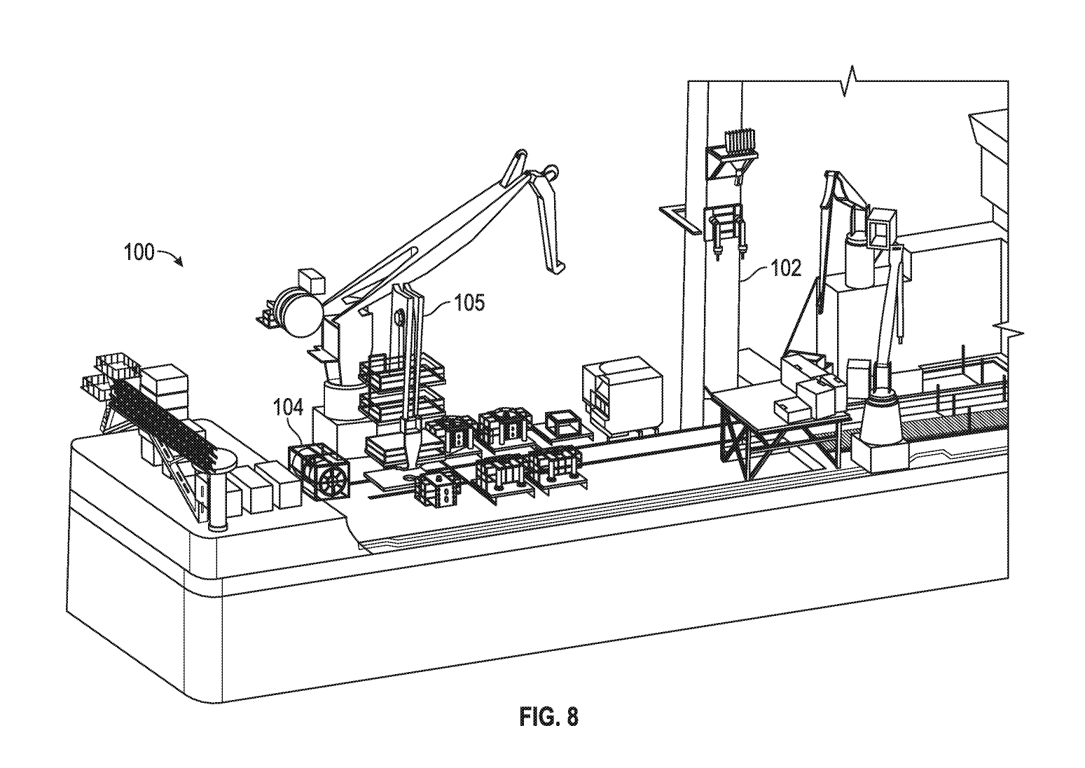

FIG. 8 shows a perspective view of a preferred embodiment of the well intervention monohull showing the single point land out of the intervention riser system and intervention lift frame 105 in parking position. The surface coiled tubing reels 104 and the open derrick 102 are shown herein.

While the invention has been described with reference to one or more particular embodiments, those skilled in the art will recognize that many changes may be made thereto without departing from the spirit and scope of the description. Each of these embodiments and obvious variations thereof is contemplated as falling within the spirit and scope of the claimed invention.

What is claimed is:

1. A well intervention monohull vessel comprising:
a tower type open derrick disposed on a deck of the vessel; and
at least one single point land out capable of being connected to the open derrick.

2. The vessel of claim 1 further comprising:
an intervention riser system; and
an emergency disconnect package;
wherein the intervention riser system and the emergency disconnect package are capable of being transported on the deck.

3. The vessel of claim 1 further comprising a moonpool door.

4. The vessel of claim 2 further comprising a moonpool door capable of transporting the intervention riser system.

5. The vessel of claim 1 further comprising an intervention lift frame.

6. The vessel of claim 1 further comprising at least one surface coiled tubing reel disposed on the deck.

7. The vessel of claim 1 further comprising at least one riser storage area.

8. The vessel of claim 1 further comprising:
at least one rail; and
at least one pallet.

9. The vessel of claim 1 further comprising at least one subsea tree.

10. The vessel of claim 1 further comprising at least one crane disposed on the deck.

11. The vessel of claim 1 comprising at least one drawwork in connection with the single point land out.

12. A method of using a monohull vessel comprising the steps of:
(a) placing a tower type open derrick on a deck of the monohull vessel;
(b) drawing at least one single point land out capable of being connected to the open derrick.

13. The method of claim 12 further comprising the steps of:
(c) disposing an intervention riser system and an emergency disconnect package via the single point land out.

14. The method of claim 13 wherein Step (c) further comprises transporting the intervention riser system via a moonpool door on the vessel.

15. The method of claim 12 further comprising an intervention lift frame.

16. The method of claim 12 further comprising:
at least one rail; and
at least one pallet.

17. The method of claim 12 further comprising at least one crane disposed on the deck.

18. The method of claim 12 comprising at least one drawwork in connection with the single point land out.
